(19) United States
(12) Patent Application Publication
(10) Pub. No.: US 2010/0227162 A1
(43) Pub. Date: Sep. 9, 2010

(54) Atom transfer radical polymerization (ATRP) based inorganic polymer structures

(76) Inventors: ABHIMANYU ONKAR PATIL, Westfield, NJ (US); ANDY HAISHUNG TSOU, Allentown, PA (US); HONGCHEN DONG, Pittsburgh, PA (US)

Correspondence Address: ExxonMobil Research & Engineering Company, P.O. Box 900, 1545 Route 22 East, Annandale, NJ, 08801-0900, US

(21) Appl. No.: 12/380,689

(22) Filed: Mar. 3, 2009

(51) Int. Cl. B32B 5/16; C08L 51/10

(52) U.S. Cl. 428/338; 525/63

(57) ABSTRACT

A modified inorganic substrate having a plurality of grafts of a polyalkyl acrylate or methacrylate of mean alkyl pendant chain length of 6 to about 40 carbons extending therefrom. The modified inorganic substrate is preferably a modified silica substrate and more preferably modified silica nanoparticles. There is also a process for graft polymerizing a silica substrate.

### FIELD

The present disclosure relates to a modified inorganic substrate having a plurality of grafts of polyalkyl acrylates extending therefrom. The present disclosure also relates to modified silica nanoparticles. The present disclosure further relates to a process for atom transfer radical polymerization (ATRP) of alkyl acrylate polymers onto inorganic substrates. The present disclosure yet further relates to a process for ATRP of alkyl acrylate polymers onto silica nanoparticles.

### BACKGROUND

Inorganic substances have been incorporated into organic polymers and polymer composites for a variety of purposes. Such purposes include, for example, as fillers to improve mechanical and thermal properties, to decrease shrinkage and internal stresses during fabrication of polymer articles, to increase thermal conductivity, enhance thermal stability, increase flame resistance, and to improve cost effectiveness.

Incorporation of inorganic substances into organic polymers and polymer composites can be problematic as the two may be immiscible. An example is the immiscibility of inorganic substances and polyolefins. Compatibilizers are sometimes used to mix immiscible materials. Mixers and/or extruders are also sometimes used. Inorganic materials may also be surface-treated to enhance miscibility. An example of surface treatment is the polymerization of polymer brushes on the surface of inorganic materials. The polymerization of polymer brushes on silica nanoparticles is disclosed, for instance, in U.S. Pat. No. 6,627,314 B2.

Nanocomposites are materials that contain nanofillers or fillers of nanometer particle diameter, e.g., 100 nanometers or less. Hybrid organic polymer-inorganic nanocomposite materials are promising for a variety of applications because of their unique electronic, optical, and mechanical properties.

Nanocomposites of interest include those having chemically modified porous silica and organic polymers. Silica nanoparticles can be functionalized to provide them with solubility in a target media. One technique for modifying silica particles is the “grafting-to” method, wherein end-functionalized polymers react with the functional groups on the inorganic particle surface. Another technique is the “grafting-from” method, wherein polymer chains grow from initiator-modified inorganic particle surfaces or initiator-functionalized self-assembled monolayers. Because of the steric hindrance imposed by the grafted polymer chains, it is difficult to prepare high-density polymer-grafted particles using “grafting-to” methods. Higher grafting densities can be obtained by using “grafting from” methods.

In a surface-initiated ATRP process, polymer chains grow from initiators that were previously anchored to the particle surface. Consequently, the grafted chains do not hinder the diffusion of the small monomers to the reaction sites, so well-defined polymers chains with higher graft density can be obtained.

Polymer brushes are dense layers of polymer chains confined to a surface or interface, wherein the distance between grafts is much less than the unperturbed dimensions of the tethered polymer. Due to high steric crowding, grafted chains extend from the surface and reside in an entropically unfavorable conformation. Polymer brushes have been prepared by the end-grafting of chains to/from flat or curved surfaces that are organic or inorganic in nature. These include functional colloids, highly branched polymers and block copolymer aggregates, such as micelles or phase-separated nanostructures.

It would be desirable to have nanocomposite particles having polymer brushes that can be prepared with predetermined molecular weights and narrow polydispersities. It would further be desirable to have a process for preparing nanocomposite particles having polymer brushes.

### SUMMARY

According to the present disclosure, there is a modified inorganic substrate having a plurality of grafts of long alkyl chain polyalkyl acrylates and methacrylates having a mean alkyl pendant chain length of 6 to about 40 carbons extending therefrom. The modified inorganic substrate is preferably a modified silica substrate and more preferably modified silica nanoparticles.

Further according to the present disclosure, there is a process for graft polymerizing a silica substrate. The process has the steps of (a) modifying a surface of the silica substrate to form a plurality of halogen (bromine, chlorine) reactive sites and (b) graft polymerizing the halogen reactive sites in the presence of long alkyl chain polyalkyl acrylates having 6 to about 40 carbons.

### DETAILED DESCRIPTION

All numerical values in this disclosure are understood as being modified by “about” or “approximately” the indicated value, and take into account experimental error and variations that would be expected by a person having ordinary skill in the art.

Polyolefins (POs), represented by polyethylene and polypropylene, are important polymeric materials. They are high volume polymers and their worldwide use reflects the fact that POs possess excellent properties, for example, good mechanical strength, flexibility, chemical stability and processability. To broaden their applications even further, a lot of effort has been made to create new olefinic polymers or copolymers, for instance, polyolefins that link polar (monomer/polymer) segments.

Some polyolefins, like polyethylene, are non-polar and immiscible with polar polymers or inorganic materials and fillers. Compatibilizers are often used to mix immiscible polymers. Inorganic support based polymer brushes may help compatiblize polyolefins with inorganic material or fillers.

One aspect of the present disclosure relates to the synthesis of high-density long crystallizable hydrophobic side chain containing polymer brushes onto silica or inorganic support. Initially atom transfer radical polymerization (ATRP) initiator-modified silica was prepared and then surface-initiated ATRP (“grafting-from” method) was carried out with long chain acrylate, such as octadecyl acrylate, where alkyl chain length is more than 4 carbons. The resultant polymer-grafted silica was used to study compatibility of polyethylene with silica to obtain polymer-inorganic hybrid nanocomposites.

The objective of the polymer-inorganic hybrid material preparation is in compatabilizing interfaces between organic and inorganic matter as a route to combine the advantageous properties of both components. Recent developments in polymer chemistry offer the synthetic chemist a wide range of tools to prepare well-defined, highly functional building blocks. Controlled/“Living” Radical Polymerization (CRP) has been shown to be suitable for the preparation of organic/inorganic hybrid materials with varying structural complexity. ATRP is especially well suited for surface modification and the preparation of molecular brushes because hydroxyl groups on the surface can be easily converted to ATRP-active initiators:R-bromoesters.

Controlled radical polymerization (CRP) has proved to be a versatile and robust method to prepare well-defined organic polymers. In the past decade, several techniques have been developed to synthesize well-defined polymers via radical polymerization. A major difference between conventional radical [i.e., azobis(isobutyronitrile)- or peroxide-initiated processes] and CRP is the lifetime of the propagating radical during the course of the reaction. In conventional radical processes, radicals generated by decomposition of the initiator undergo propagation and bimolecular termination reactions within a second. In contrast, the lifetime of a growing radical can be extended to several hours in a CRP, enabling the preparation of polymers with predefined molar masses, low polydispersity, controlled compositions, and functionality.

The mechanism invoked in CRP processes to extend the lifetime of growing radicals utilizes a dynamic equilibration between dormant and active sites with rapid exchange between the two states. Unlike conventional radical processes, CRP requires the use of persistent radical (deactivator) species, or highly active transfer agents to react with propagating radicals. These persistent radicals/transfer agents react with radicals (deactivation or transfer reactions) to form the dormant species. Conversely, propagating radicals are generated from the dormant species by an activation reaction.

In the past decade, the field of CRP has seen tremendous development as evidenced by the wide range of materials that have been prepared using these techniques. In particular, three methods of considerable importance are as following: stable free-radical polymerization [SFRP; e.g., nitroxide-mediated processes (NMP)], metal-catalyzed atom transfer radical polymerization (ATRP), and degenerative transfer polymerization [e.g., reversible addition-fragmentation chain transfer (RAFT) polymerization].

The main advantage of “living” radical polymerization over prior living polymerization is that one can polymerize a broad range of monomers. Moreover, unlike living anionic polymerization, which require very stringent conditions—practically zero moisture, zero air, and no impurities—these radical reactions can be carried out using less stringent conditions.

Atom-transfer radical polymerization (ATRP) is one of the several techniques for controlled/“living” radical polymerizations that yields well defined (co)polymers with precisely controlled architecture and functionality. The ATRP can be used to polymerize several monomers under conditions that are much less rigorous than previously required for ionic living polymerizations. ATRP is among the most efficient and robust CRP processes.

Another aspect of the present disclosure, is the ATRP of monomers such acrylate or methacrylate monomers with long, crystallizable hydrophobic side chains (alkyl chain length of at least more than 4 methylene groups). For example, polymerization of ODA was developed and optimized to produce PODA comb polymers with predetermined molecular weights and narrow polydispersities. The polymers were characterized by IR, NMR and GPC. The blends of high density polyethylene with PODA were prepared in the ratio of 80:20 by mixing at 180° C. for 2 minutes and morphology of the blends was evaluated by scanning electron microscopy (SEM). The SEM data suggest that PODA domain appears to be evenly distributed in polyethylene and gives phase separated morphology. The PODA can be used to blend with other polyolefins. Besides PODA one can synthesize copolymers of such acrylates and other vinyl monomers such as α-olefin, styrene or their derivatives.

Another aspect of the present disclosure relates to synthesis and characterization of novel polymeric and composite materials, with an emphasis on the control of structures on the molecular and nanoscale dimensions that offers the possibility of designing specific properties into materials that are otherwise inaccessible. We are particularly interested in compatabilizing interfaces between organic and inorganic matter as a route to combine the advantageous properties of both components. Atom transfer radical polymerization (ATRP) has been particularly successful for the synthesis of nanocomposite structures since inorganic particles and substrates can be easily functionalized with initiating alkyl halides and the resulting functional inorganic material is suitable for use in the CRP of organic vinyl monomers.

The ATRP of octadecyl acrylate (ODA) (monomer with long hydrophobic side chains to obtain comb polymers) has been investigated and optimized to produce polymers with predetermined molecular weights and narrow polydispersities. We have used soluble alkyl substituted 2,2-bipyridine with Cu(I)Br and ethyl-2-bromoisobutyrate (EBiB) as initiator for polymerization. To introduce high-density polymeric organic phase onto silica, initiator-modified silica was prepared and then surface-initiated ATRP (“grafting-from” method) was carried out with ODA. The resultant polymer-grafted silica can be used to study compatibility of polyethylene with silica.

The chemical grafting of polymer films (polymer brushes) on various inorganic substrates can be extended to other nanoparticles (with at least one dimension of the particle is <100 nm) such as mesophorous MCM-41 and plate-like ZrP material to generate polymeric nanocomposites or organic inorganic nanoparticles. Other inorganic substrates include silicates (mica, clay, talc), phosphates, and graphitic carbon (tubes, fibers, black) that have oxidized surfaces containing hydroxyl, ester, ether, and other surface functional groups.

The concept of ATRP was applied with copper-mediated atom transfer radical polymerization using relatively inexpensive alkyl halides as initiators and copper complexes with simple commercially available ligands as the catalytic system. ATRP adapts a known organic-chemistry reaction, atom transfer radical addition, to polymer synthesis. Other transition metals can be applied as catalysts for ATRP, most notably ruthenium

Copper mediated living polymerization is being used in the art to prepare block copolymers, star copolymers, and polymers from surfaces. Applications being investigated are for potential application in areas as diverse as chromatographic separation, new therapeutics, dispersants for pigments and particulates, sealants, coatings, personal care products, etc.

However, the commercial impact of CRP for novel products has not yet materialized. This may be due to a complex combination of reasons which include technical, commercial, IP based, etc. Improvements are needed in levels of catalyst required, ligands employed, and the purification and catalyst removal/product isolation.

ATRP is effective for monomers like acrylates and styrene but is not useful for monomers like ethylene or α-olefins like 1-hexene, 1-octene, or 1-decene. Polymers of monomers possessing long side chains such as poly(octadecyl acrylate) (PODA) are often termed comb-like or comb polymers. The polymerization of octadecyl acrylate (ODA) is of interest because it has hydrophobic crystallizable polymethylene structure in the side chain at the same time it contains ATRP feasible acrylic functional group.

Monomers useful in the present disclosure include polyalkyl acrylates, such as acrylates and methacrylates, having long crystallizable hydrophobic side chains (mean pendant alkyl chain length of 6 to about 40 carbons). Useful monomers include the following: 2-ethylhexyl(meth)acrylate, octyl(meth)acrylate, nonyl(meth)acrylate, isooctyl(meth)acrylate, isononyl(meth)acrylate, 2-tert-butylheptyl(meth)acrylate, 3-isopropylheptyl(meth)acrylate, decyl(meth)acrylate, undecyl(meth)acrylate, 5-methylundecyl(meth)acrylate, dodecyl(meth)acrylate, 2-methyldodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate; (meth)acrylates derived from unsaturated alcohols, such as oleyl(meth)acrylate; cycloalkyl(meth)acrylates, such as 3-vinyl-2-butylcyclohexyl(meth)acrylate and bornyl(meth)acrylate.

Additional useful monomers include the following: 2-ethylhexylacrylate, octylacrylate, nonylacrylate, isooctylacrylate, isononylacrylate, 2-tert-butylheptylacrylate, 3-isopropylheptylacrylate, decylacrylate, undecylacrylate, 5-methylundecylacrylate, dodecylacrylate, 2-methyldodecylacrylate, tridecylacrylate, 5-methyltridecylacrylate, tetradecylacrylate, pentadecylacrylate, hexadecylacrylate, 2-methylhexadecylacrylate, heptadecylacrylate, 5-isopropylheptadecylacrylate, 4-tert-butyloctadecylacrylate, 5-ethyloctadecylacrylate, 3-isopropyloctadecylacrylate, octadecylacrylate, nonadecylacrylate, eicosylacrylate, cetyleicosylacrylate, stearyleicosylacrylate, docosylacrylate and/or eicosyltetratriacontylacrylate; acrylates derived from unsaturated alcohols, such as oleylacrylate; cycloalkylacrylates, such as 3-vinyl-2-butylcyclohexylacrylate and bornyacrylate. A preferred monomer is octadecyl acrylate.

Polymerization of octadecyl acrylate via ATRP is schematically shown below.

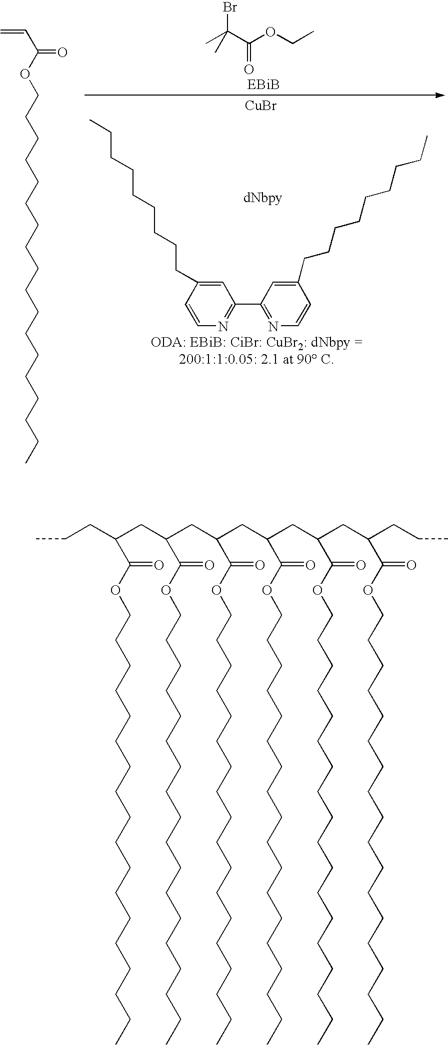

ATRP is one of the controlled/living radical polymerizations yielding well defined (co)polymers, nanocomposites, and molecular hybrids. Macromolecules with precisely controlled architecture and functionality have been synthesized from a wide range of monomers under conditions that are much less rigorous than previously required for ionic living polymerizations. ATRP is among the most efficient and robust CRP processes.

ATRP controls free-radical polymerization by the reversible activation/deactivation of growing chains. A small amount of the chains remain active during the reaction, whereas the majority of the chains laid dormant awaiting reactivation. Thus, the concentration of free-radical species is kept low and, consequently, termination processes are suppressed. It is the suppression of the termination process, particularly combination reactions that help ATRP, and the other controlled radical polymerization methods, to achieve the controlled molecular weights and low polydispersities in the final products. Equilibrium is most commonly maintained by the reversible cleavage of a carbon halogen bond of an alkyl halide mediated by the presence of a copper(I) catalyst and a suitable ligand. The cleavage results in a copper(II) complex and an alkyl radical that can either undergo deactivation, propagation with monomer units, or irreversibly terminate (Scheme 1).

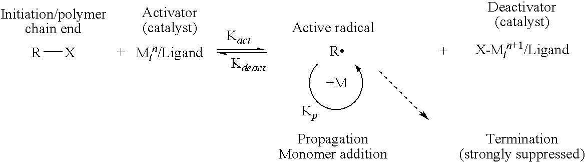

Chemically modified porous silica with polymers is of interest for nanocomposite material. Two main goals of functionalizing nanoparticles are to provide them with solubility in necessary media and, as a result, easy processing for target applications. There are two principal techniques for the modification of silica particles (as well as inorganic surfaces in general): (1) the “grafting-to” method, where the end-functionalized polymers react with the functional groups on the inorganic particle surface; and (2) the “grafting-from” method, where the polymer chains grow from the initiator-modified inorganic particle surface or initiator-functionalized self-assembled monolayer. Because of the steric hindrance imposed by the grafted polymer chains, it is difficult to prepare high-density polymer-grafted particles using “grafting to” methods. A higher grafting density can be obtained by using “grafting from” method.

Compared to small molecular stabilizers, polymeric stabilizers are able to enhance the particle's long term stability and tune the solubility and amphiphilicity for specific applications. The synthetic route to silica-polymer hybrid nanoparticles involves two steps: 1) attachment of a monolayer of ATRP initiators to the particle surface; and 2) surface initiated polymerization.

One approach to prepare nanocomposites has been the incorporation of well-defined organic and inorganic components into a singular material. In particular, the inclusion of well-defined polymers to inorganic substrates is of significance, because the functionality, composition, and dimensions of these macromolecules enable the design of specific properties into the resulting hybrid.

Modification of surfaces is an important area. By grafting well-defined polymers from a surface, one can change its behavior and materials with totally new properties. When one grows polymers from a surface by adding units one by one to create the desired responsive surface, one obtains dense polymer films that can change the lubrication properties of the surface, get a different compressibility, and prevent corrosion.

As used herein, “controlled polymerization” means that in the polymerization process chain breaking reactions are insignificant compared to chain propagation reactions, and the resulting polymers were produced with molecular weight control, narrow polydispersity, end-group control and the ability to further chain extend.

Another aspect of the disclosure is directed towards the preparation of nanocomposite particles with a silicon based particle core having an attached or tethered polymer comprising free radically (co)polymerizable monomer units. One method of the present disclosure for producing such nanocomposite particles involves use of a functional colloid comprising polymerization initiation sites. The functional colloids may comprise functional silica particles and silicate based particles, including, but not limited to, polysilesquioxane colloidal particles possessing initiating groups for ATRP. Other inorganic substrates include silicates (mica, clay, talc), phosphates, and graphitic carbon (tubes, fibers, black) that have oxidized surfaces containing hydroxyl, ester, ether, and other surface functional groups. Preparation of Such Particles and the Use of Such Nanoparticles as Multi-Functional initiators for polymerization process to produce particles with tethered or grafted polymers is taught herein.

During the preparation of silica based particles with attached initiator groups, in order to avoid coagulation, a solvent switch technique is taught whereby one can prepare well separated, redispersible silica particles with particle sizes between 5 and 1000 nm, preferably particles having diameters between 10 and 100 nm, comprising functional initiator groups on the surface on the surface of the particles. Nanoparticles with monomodal narrow particle size distributions produce more uniform nanocomposite structures, in most cases. Preferably, a distribution of particles wherein 67% of the particles are within 10% of the mean is a narrow particle size distribution and will produce a substantially uniform nanocomposite structure.

The present disclosure provides processes for the preparation of such nanocomposite materials. Specifically for ATRP, a process of the present disclosure comprises first polymerizing one or more free radically polymerizable (co)monomers in the presence of an initiation system and, further polymerizing one or more second radically polymerizable (co)monomers. The initiation system comprises a functional particle initiator and a catalyst. The functional particle initiator may comprise, for example, a silica particle or a silicate particle or a polysilsesquioxane particle and an attached functional group comprising a radically transferable atom or group. The catalyst may comprises a transition metal complex that participates in a reversible redox cycle with at least one of the attached functional groups and an attached compound having a radically transferable atom or group, such as, the growing polymer chain.

The monomers available are any free radically (co)polymerizable long alkyl chain containing acrylate monomers. In the preparation of high molecular weight tethered grafted polymer chains, the ratio of transition metal to radically transferable atoms of groups can be increased to ratio's greater than one in order to increase the rate of polymerization while allowing the polymerization to be conducted at high dilution. Conducting polymerizations at high dilution reduces the likelihood of interparticle coupling reactions.

The synthesis of the inorganic colloidal initiator particles may conducted in a solvent such as, for example, tetrahydrofuran (THF). The initiator particles produced by this process were capable of being isolated and, subsequently, redispersed. It may be desirable to conduct only a partial initial surface treating reaction with a surface treating agent comprising the desired functionality than described in the literature to provide particles with remaining residual reactive surface sites. These sites are then able to react in a second surface treatment with molecules capable of incorporating a second functional group suitable as a functional group for initiating ATRP, for example. As used herein, a surface treating agent is a molecule, such as a monoalkoxysilane, which will react with the particle surface. The surface treating agent may incorporate desired functionality or be used to stabilize the particle surface. In the examples described later, substantially uniform particles with diameters between 15-20 nm and 1000 initiation sites on the surface were prepared. The number of initiating sites can be varied by varying the ratio of the surface treating agents and could vary from an average of one up to 1,000,000 or more depending on particle size and initiation site density; exemplary particles with 300 to 3000 initiating sites were prepared, however this range can be expanded using the methods described herein if desired. It is expected that the preferred number of functional groups on each particle would be in the range of 100 to 100,000, and more preferably in the range of 300 to 30,000 to produce the advantageous properties of the nanocomposite particles and structures. Particles preferably have a chain density of from 0.01 chain to 5 chains per square nanometer (nm²). Control over the number of initiating sites on a particle allows one to control the graft density of the attached polymer chains and thereby the packing density of the polymer chains. A high density of initiating sites provides for maximum incorporation of grafted polymer chains and, such high graft density provides tethered chains that are in an extended, brush-like state.

The inorganic substrate has a plurality of grafts of a polyalkyl acrylate or methacrylate extending therefrom having a mean alkyl pendant chain length of 6 to about 40 carbons extending therefrom and preferably 8 to about 20 carbons extending therefrom.

It is advantageous to confirm and measure the number of attached initiator functional groups prior polymerization of the multifunctional initiator particles for construction of nanocomposite particles or structures.

Step # 1: Synthesis of ATRP Initiator (1-(chlorodimethylsilyl)propyl 2-bromoisobutyrate) (25581-7)

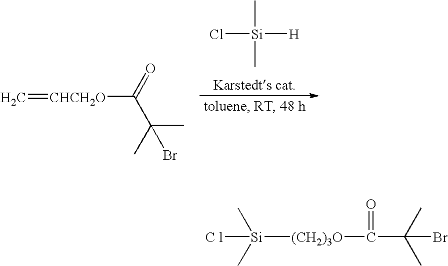

Karstedt's catalyst: platinum(0)-1,3-divinyl-1,1,3,3-tetramethyldisiloxane complex solution in xylene (Pt ˜2%).

Allyl 2-bromo-2-methylpropionate (Aldrich, 98%) (2.5 mL, 15.4 mmol) and dry toluene (30 mL) were added into a round bottom flask and purged with N₂. Chlorodimethylsilane (Aldrich, 98%) (12.2 mL, 107.8 mmol) was added dropwise into the flask, and subsequently Karstedt's catalyst solution (300 μL) was added into the system via a syringe. The mixture was stirred under N₂ for over 62 hours. The conversion was determined by IR. (all double bond peaks of the vinyl groups disappeared). The unreacted chlorodimethylsilane and toluene was distilled under vacuum, giving yellow oil with 100% yield. The Karsted's catalyst could be partially removed by filtration with 200 nm filter.

### Step # 2. Synthesis of 2-Bromoisobutyrate Functional Silica Colloids (25581-8)

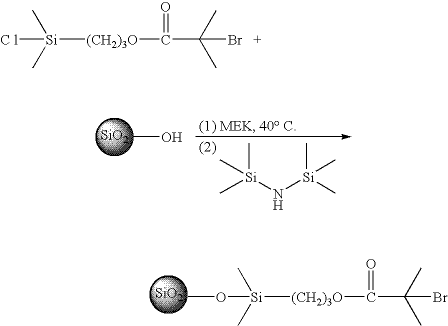

The silica dispersion (13.0 g of 30 wt % SiO₂ in methyl ethyl ketone, particle size of SiO₂ ˜15 to 20 nm, Nissan) was added to a 100 mL round bottom flask, and protected with nitrogen. The 1-(chlorodimethylsilyl)propyl 2-bromoisobutyrate (1.5 mL) was then added via syringe. The orange dispersion became cloudy. The reaction mixture was stirred for 24 hours at 50° C. The mixture was cooled down to room temperature and hexamethyldisilazane (1.5 mL, Aldrich) was then added. The mixture was stirred at room temperature for 3 hours, and heated at 40° C. for overnight. The precipitate was removed by centrifugation (5000 rpm for 0.5 hour), and the supernatant was added dropwise into hexane to precipitate colloids. The particles were washed with hexane for several times. And then hexane was removed by rotary evaporator, yielding 5.3 grams of white yellow solid. The bromine content of the initiator-modified silica nanoparticles was determined by elemental analysis, as 1.41 wt % or 0.177 mmol Br/g SiO₂.

### EXAMPLES

Colloidal silicas modified with poly(octadecyl acrylate) were prepared in accordance with the present disclosure.

### Example # 1

### ATRP of ODA from 2-Bromoisobutyrate Functional Silica Colloids (25581-20)

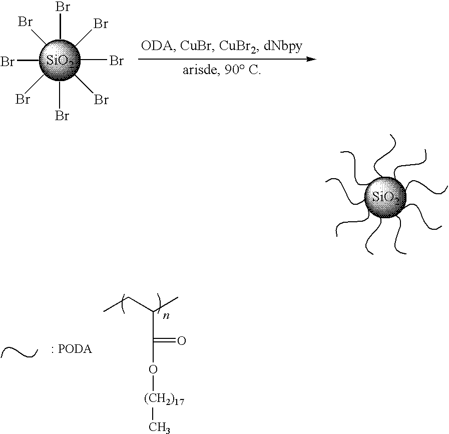

Octadecyl acrylate (ODA, Aldrich, 97%) (2.4 g, 7.17 mmol), 2-bromoisobutyrate functional silica colloids (100 mg, 0.0177 mmol Br), CuBr (Aldrich, 99.999%) (5.2 mg, 35.9 μmol) and 4,4′-dinonyl-2,2′-dipyridyl (dNbpy, Aldrich, 97%) (31.7 mg, 75.3 μmol) were added into 100 mL round bottom flask with side arm. And then the flask was sealed with a glass stopper and purged with N₂ for about 1 hour. 4.0 mg (17.9 μmol) CuBr₂ was dissolved in 1 mL dimethyl sulfoxide (DMSO). And then 0.1 mL the above solution mixed with 1.4 mL anisole. The mixture was purged with N₂ for 10 min. The above mixture was injected into the reaction flask. The flask was placed in a thermostated oil bath at 90° C. The reaction solution became brown. After 17.5 hours, about 0.2 mL reaction solution was taken out via syringe under N₂ protection. The sample was analyzed by ¹H-NMR (CDCl₃ as the solvent) to determine the reaction conversion. Monomer conversion=6.8%. The oil bath temperature was increased to 105° C. at 20 hours. After 24 hours, monomer conversion=7.0%. The TGA of SiO₂—PODA gave a weight loss of 78.39% with residue of 21.61%. After 68 hours, the reaction was stopped by exposing to air. Monomer conversion=18.7%. The TGA of SiO₂—PODA gave a weight loss of 87.87% with residue of 12.13%. The reaction solution was diluted with THF, and added dropwise into acetone, yielding white SiO₂-g-PODA powder.

The SiO₂-PODA sample was used for solid state ¹³C NMR studies. Although the solid state room temperature (28° C.) NMR showed broad peaks, there was a dramatic improvement in resolution when sample was heated to 50° C. In fact, the solid state spectrum at elevated temperature was similar to the solution spectrum. We calculated the molecular weight of the PODA attached to silica using two separate procedure using ¹³C NMR spectrum. Using the signal of polymer carbons vs. dimethyl carbon attached to silica from initiator, the molecular weight of the PODA is estimated to be 17108. Using the signal of polymer carbons (PODA) vs. dimethyl carbon, Si(CH₃)₂, attached to carbon from initiator, the molecular weight of the PODA was estimated to be 16043. We calculated the molecular weight of the PODA attached to silica using ¹H NMR spectrum. Using the signal of polymer hydrogens (PODA) vs. dimethyl hydrogen, Si(CH₃)₂, attached to silica from the initiator, the molecular weight of the PODA is estimated to be 17208. All these three molecular weight values are in agreement with each other. This may be a unique approach to calculate the molecular weight of the polymer attached to inorganic material like silica gel.

An XPS spectra of SiO₂ modified with an ATRP initiator and PODA polymer brushes was obtained. The SiO₂ modified with ATRP initiator shows typical SiO₂ features with Si and oxygen peaks. The carbon peak arising from three methylene of initiator portion of the molecule is clearly seen. A tiny peak at extreme right due to chain end Br is also seen. The PODA polymer brushes showed a decrease in SiO₂ features with extremely small Si peaks and a substantially reduced oxygen peak compared to the carbon peak. The carbon peak is arising from the PODA polymer.

The potentially unreacted free initiator was washed from SiO₂-modified initiator. The only way PODA can be obtained via polymerization from initiator is that attached to silica gel, and, hence, it can be concluded that PODA is grafted onto silica particle and it is not a simple mixture of silica gel and PODA polymer.

### Example 2

### ATRP of ODA from 2-Bromoisobutyrate Functional Silica Colloids with Large Scale (25581-35)

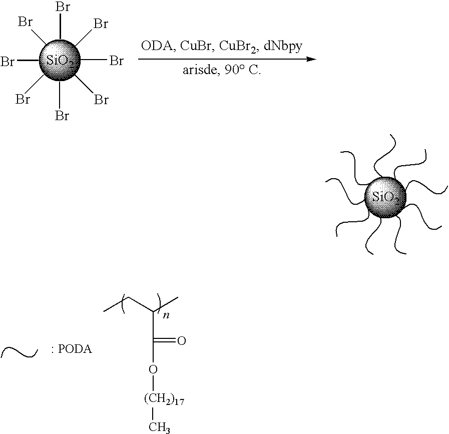

Octadecyl acrylate (ODA, Aldrich, 97%) (12.0 g, 35.87 mmol), 2-bromoisobutyrate functional silica colloids (500 mg, 0.0885 mmol Br), CuBr (Aldrich, 99.999%) (25.7 mg, 0.179 mmol), CuBr₂ (2.0 mg, 8.97 μmol) and 4,4′-dinonyl-2,2′-dipyridyl (dNbpy, Aldrich, 97%) (158.7 mg, 0.377 mmol) were added into 100 mL round bottom flask with side arm. Then the flask was sealed with a glass stopper and purged with N₂ for about 1 hour. Anisole (7.5 mL) was purged with N₂ for 40 min, and then was injected into the reaction flask. The flask was placed in a thermostated oil bath at 90° C. The reaction solution turned green from brown after 30 minutes. Tin(II) 2-ethylhexanoate (Sn(EH)₂, Aldrich, 98%) (190.70 mg, 94.1 μmol) was dissolved in 1 mL anisole. The solution was bubbled with N₂ for about 20 minutes. At 4.5 hours into the reaction, 0.2 mL Sn(EH)₂ anisole solution was injected into the reaction. The solution became brown again. After 43.7 hours, the reaction was stopped by exposing to air. Monomer conversion=17.4%. The reaction solution was diluted with THF, and added dropwise into acetone, yielding white green SiO₂-g-PODA powder about 3 grams. The TGA of SiO₂—PODA gave a weight loss of 71.15%.

### Example 3

### Polymerization of Octadecyl Acrylate via ATRP (25581-1) PODA was as Synthesized with dNbpy as a Ligand According to the Following

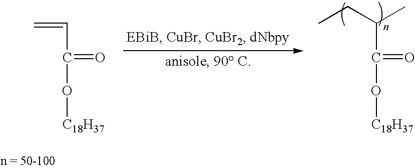

All procedures were carried out under a nitrogen atmosphere with freshly dried and distilled solvents and Schlenk techniques.

Octadecyl acrylate (ODA, Aldrich, 97%) (2.4 g, 7.17 mmol), CuBr (Aldrich, 99.999%) (5.2 mg, 35.9 μmol) and 4,4′-dinonyl-2,2′-dipyridyl (dNbpy, Aldrich, 97%) (31.7 mg, 75.3 μmol) were added into 100 mL round bottom flask with side arm. Then the flask was sealed with a glass stopper and purged with N₂ for about 1 hour. 4.0 mg (17.9 μmol) CuBr₂ was dissolved in 0.1 mL dimethyl sulfoxide (DMSO), and then 1.4 mL anisole was added. The mixture was purged with N₂ for 10 min. The initiator ethyl 2-bromoisobutyrate (EBiB, Aldrich, 98%) (0.359 mmol, 53.7 μL) was then added into the CuBr₂ solution. About 0.15 mL of the above solution was injected into the reaction flask. The flask was placed in a thermostated oil bath at 90° C. The reaction solution became brown. After 4.4 hours, about 0.2 mL of reaction solution was taken out via syringe under N₂ protection. The sample was analyzed by ¹H-NMR (CDCl₃ as the solvent) to determine the reaction conversion and by GPC to measure molecular weight and its polydispersity. Monomer conversion=10.1%. Mₙ=9,190. M_{w}/Mₙ=1.13. After 20.7 hours, the reaction was stopped by opening the flask and exposing the catalyst to air. The reaction solution became green. The product was analyzed by ¹H-NMR and GPC. Monomer conversion=39.2%. Mₙ=24,970. M_{w}/Mₙ=1.11.

Semilogarithmic kinetic plots and dependence of molecular weights and molecular weight distributions for ATRP of ODA with dNbpy as a ligand and copper-mediated polymerizations were evaluated. The molecular weight increased linearly with conversion and the molecular weight distribution remained low and constant. The SEC traces for ATRP of ODA with dNbpy as a ligand were reviewed to track the evolution of molecular weights and molecular weight distribution. The molecular weight increased and the distribution shifted towards higher molecular weight. The molecular weight distribution remains low and constant confirming negligible termination and transfer.

The polymerization of octadecyl acrylate is of interest as a component in coatings applications possessing highly hydrophobic crystallizable side chains. It also offers interest as a components of smart paints because the crystallization is temperature switchable, with a transition around 55-56° C. Therefore, the degree of controlled by CRP over molecular weight characteristics of ODA polymers is of interest.

### Example 4

### Polymerization of Octadecyl Acrylate Via ATRP at Higher Temperature (25581-11)

Octadecyl acrylate (ODA, Aldrich, 97%) (2.4 g, 7.17 mmol), CuBr (Aldrich, 99.999%) (5.2 mg, 35.9 μmol) and 4,4′-dinonyl-2,2′-dipyridyl (dNbpy, Aldrich, 97%) (31.7 mg, 75.3 μmol) were added into 100 mL round bottom flask with side arm. Then the flask was sealed with a glass stopper and purged with N₂ for about 1 hour. 4.0 mg (17.9 μmol) CuBr₂ was dissolved in 0.1 mL dimethyl sulfoxide (DMSO), and then 1.4 mL anisole was added. The mixture was purged with N₂ for 10 min. The initiator ethyl 2-bromoisobutyrate (EBiB, Aldrich, 98%) (0.359 mmol, 53.7 μL) was then added into the CuBr₂ solution. About 0.15 mL of the above solution was injected into the reaction flask. The flask was placed in a thermostated oil bath at 95° C. The reaction solution became brown. After 1.5 hour, about 0.2 mL reaction solution was taken out via syringe under N₂ protection. The sample was analyzed by ¹H-NMR (CDCl₃ as the solvent) to determine the reaction conversion and by GPC to measure molecular weight and its polydispersity. Monomer conversion=7.8%. Mₙ=6,010. M_{w}/Mₙ=1.21. After 3.2 hours, monomer conversion=13.8%. Mₙ=10,190. M_{w}/Mₙ=1.12. After 5.3 hours, monomer conversion=21.6%. Mₙ=13,690. M_{w}/Mₙ=1.13. After 20.8 hours, monomer conversion=48.2%. Mₙ=26,530. M_{w}/Mₙ=1.12. After 29.0 hours, the reaction was stopped by opening the flask and exposing the catalyst to air. The reaction solution became green. The product was analyzed by ¹H-NMR and GPC. Monomer conversion=50.0%. Mₙ=28,120. M_{w}/Mₙ=1.15. The reaction solution was diluted with tetrahydrofuran (THF), and passed through a short basic alumina column to remove copper catalyst. The resulting solution was added dropwise into acetone, yielding white PODA powder.

Semilogarithmic kinetic plots and dependence of molecular weights and molecular weight distributions for ATRP of ODA with dNbpy as a ligand were evaluated. The molecular weight increased linearly with conversion and the molecular weight distribution remained low and constant. The SEC traces for ATRP of ODA with dNbpy as a ligand were reviewed to track the evolution of molecular weights and molecular weight distribution. The molecular weight increased and the distribution shifted towards higher molecular weight. The molecular weight distribution remained low and constant confirming negligible termination and transfer.

Using a higher reaction temperature of 95° C., the reaction conversion increased somewhat (39.2% vs. 48.2% after 20 hours). To evaluate the effect of ligand on rate of reaction, a different ligand was used in Example 5.

### Example 5

### Polymerization of Octadecyl Acrylate Via ATRP (25581-4) Octadecyl Acrylate is Polymerized Via ATRP with PMDETA as a Ligand

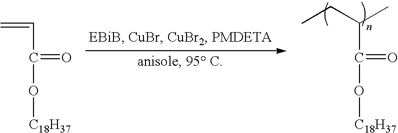

Octadecyl acrylate (ODA, Aldrich, 97%) (2.4 g, 7.17 mmol) and CuBr (Aldrich, 99.999%) (5.2 mg, 35.9 μmol) were added into 100 mL round bottom flask with side arm. Then the flask was sealed with a glass stopper and purged with N₂ for about 1 h. 4.0 mg (17.9 μmol) CuBr₂ was dissolved in 0.1 mL dimethyl sulfoxide (DMSO), and then 1.4 mL anisole was added. The mixture was purged with N₂ for 10 min. The initiator ethyl 2-bromoisobutyrate (EBiB, Aldrich, 98%) (0.359 mmol, 53.7 μL) and the ligand N,N,N′,N″N′-pentamethyl diethylenetriamine (PMDETA, Aldrich, 99%) (79.4 μL, 0.377 mmol) were then added into the CuBr₂ solution. The flask was placed in a thermostated oil bath at 95° C. After 2.5 hours, the reaction was stopped by opening the flask and exposing the catalyst to air. The sample was analyzed by ¹H-NMR (CDCl₃ as the solvent) to determine the reaction conversion, and by GPC to measure molecular weight and its polydispersity. Monomer conversion=82.8%. Mₙ=43,980. M_{w}/Mₙ=1.43. The reaction solution was diluted with 17 mL THF, and passed through a short basic alumina column to remove copper catalyst. The resulting solution was added dropwise into acetone, yielding white PODA powder 1.66 g.

The evolution of SEC traces for ATRP of ODA with PMDETA as a ligand was evaluated. The reaction rate was very high using this aliphatic triamine ligand. The polymer conversion was 82.8% in 2.5 hours. This conversion using ligand PMET was quite high compared to conversion of 39.2% and 48.2% in 20 hours as seem in Examples 3 and 4 using dNbby ligand. The molecular weight distribution is also become broad (M_{w}/Mₙ=1.43) with high conversion.

The IR spectra of ODA monomer showed an absorption peak due to ester carbonyl at 1729 cm⁻¹ and a small double bond peaks at 1637 cm⁻¹, 1621 cm⁻¹ and 810 cm⁻¹. The IR spectrum of PODA polymer showed complete disappearance of double bond peaks at 1637 cm⁻¹, 1621 cm⁻¹ and 810 cm⁻¹ and shift in the ester peak at 1737 cm⁻¹. The shift in the ester peak was due to change in the nature of ester from an α,β-unsaturated carbonyl ester in monomer to saturated carbonyl ester in the polymer.

The ¹H-NMR of PODA in CDCl₃ was as follows: ¹H NMR (CDCl₃, 6 ppm): 0.88 [broad peak, 3H, —(CH₂)₁₇—CH₃], 1.26 [broad peak, 30H, —(CH₂)₁₅—CH₃], 1.60 [broad peak, 4H, —CH₂—CH₂—(CH₂)₁₅—, and —CH₂—CH—CH₂], 3.95 [broad peak, 2H, O—CH₂—CH₂—].

The polymerization of ODA with a typical ATRP system (Schemes 1) was very well behaved while producing low polydisperse products with very well-controlled molecular weight. This may be due to a relatively high rate of deactivation compared to the rate of propagation and high rate of initiation compared to propagation.

### Example 6

### High Density Polyethylene (HDPE) and PODA Blends (25581-9)

About 3 g high density polyethylene (HD-8661.26, Lot 314.147) and 0.75 g poly(octadecyl acrylate) (25581-4) were blended in DSM Micro 5 mixer at 180° C. for 2 minutes. The mixture was finally extruded out into a strand for scanning electron microscopy (SEM) characterization, the string of the blended sample was immersed in liquid nitrogen for 1 minute, and then broken into two parts by tweezers. The morphology of the cross section was studied by SEM. The SEM images of cross section of a blended HDPE and PODA string was studied. The SEM data suggest that PODA domain appears to be evenly distributed in polyethylene and gives phase separated morphology.

In summary, the ATRP of monomers such as acrylate or methacrylate monomers with long crystallizable hydrophobic side chains (alkyl chain length of at least more than 4 methylene groups) was demonstrated. For example, polymerization of ODA was developed and optimized to produce PODA comb polymers with predetermined molecular weights and narrow polydispersities. The polymers were characterized by IR, NMR and GPC. The blends of high density polyethylene with PODA were prepared in the ratio of 80:20 by mixing at 180° C. for 2 minutes and morphology of the blends was evaluated by SEM. The SEM data suggest that PODA domain appears to be evenly distributed in polyethylene and gives phase separated morphology. The PODA can be used to blend with other polyolefins. Besides PODA, copolymers of such acrylates and other vinyl monomers such as α-olefin, styrene or their derivatives can be synthesized.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances which fall within the scope of the appended claims.

What is claimed is:

1. A modified inorganic substrate, comprising an inorganic substrate having a plurality of grafts of a polyalkyl acrylate or methacrylate having a mean alkyl pendant chain length of 6 to 40 carbons extending therefrom.

2. The modified inorganic substrate of claim 1, wherein the inorganic substrate is silica.

3. The modified inorganic substrate of claim 2, wherein the silica takes the form of silica nanoparticles.

4. The modified inorganic substrate of claim 1, wherein the polyalkyl acrylate or methacrylate is a homopolymer.

5. The modified inorganic substrate of claim 1, wherein the polyalkyl acrylate or methacrylate is a copolymer of octadecyl acrylate and one or more other monomers copolymerizable therewith.

6. The modified inorganic substrate of claim 1, wherein the polyalkyl acrylate or methacrylate has 8 to 20 carbon atoms per graft.

7. The modified inorganic substrate of claim 3, wherein the weight ratio of acrylate polymer to inorganic substrate is 1:1 to 1000:1.

8. The modified inorganic substrate of claim 3, wherein the polyalkyl acrylate is poly(octadecyl acrylate).

9. A process for graft polymerizing a silica substrate, comprising:
modifying a surface of the silica substrate to form a plurality of halogen reactive sites and
graft polymerizing the halogen reactive sites in the presence of an alkyl acrylate or methacrylate of 6 to 40 carbons.

10. The process of claim 9, wherein the surface of the silica substrate is modified via reaction with 1-(chlorodimethylsilyl)propyl 2-bromoisobutyrate in the presence of a catalyst.

11. The process of claim 10, wherein the reaction is carried out in the presence of methyl ethyl ketone and the catalyst is hexamethyldisilazane.

12. The process of claim 10, wherein the polyalkyl acrylate is octadecyl acrylate.

13. The process of claim 9, wherein the halogen is bromine.
